(19) United States
(12) Patent Application Publication
(10) Pub. No.: US 2018/0196302 A1
(43) Pub. Date: Jul. 12, 2018

(54) DISPLAY DEVICE

(71) Applicant: Samsung Display Co., Ltd., Yongin-Si (KR)

(72) Inventors: Kwangsoo BAE, Suwon-si (KR); Jungsuk BANG, Seoul (KR); Minjeong OH, Gimpo-si (KR); Haeju YUN, Hwaseong-si (KR); Donchan CHO, Seongnam-si (KR)

(21) Appl. No.: 15/866,834

(22) Filed: Jan. 10, 2018

(30) Foreign Application Priority Data
Jan. 11, 2017 (KR) 10-2017-0004380

(51) Int. Cl. G02F 1/1335; G02F 1/1333; F21V 8/00

(52) U.S. Cl. CPC G02F 1/133509; G02B 6/0025; G02F 1/133528; G02F 1/133345

(57) ABSTRACT

A display device includes a display module, a light source, a light-guiding substrate including at least a side surface adjacent to the light source, and an optical filter provided on the light-guiding substrate. The optical filter includes a first insulating layer including a first sub-insulating layer, a second sub-insulating layer, and a third sub-insulating layer, a second insulating layer provided on the first insulating layer to be in contact with the second sub-insulating layer, and a first liquid crystal layer which selectively transmits or reflects light provided from the light-guiding substrate. The first liquid crystal layer is disposed in each of first cavities which are defined as closed spaces enclosed by the first sub-insulating layer, the third sub-insulating layer, and the second insulating layer.

This application claims priority to Korean Patent Application No. 10-2017-0004380, filed on Jan. 11, 2017, and all the benefits accruing therefrom under 35 U.S.C. § 119, the content of which in its entirety is herein incorporated by reference.

### BACKGROUND

Exemplary embodiments of the invention relate to a display device, and in particular, to a display device with a reduced thickness.

In general, a display device includes a display panel which is configured to display an image using light, and a backlight unit which is configured to generate the light and provide the light to the display panel.

An edge-type backlight unit includes a light source for generating light, a light guide plate which is used to guide the light provided from the light source toward the display panel or in an upward direction, and an optical sheet which is provided between the light guide plate and the display panel and is used to condense the light transmitting from the light guide plate toward the display panel or in the upward direction.

The optical sheet may include a diffusion sheet for diffusing the light, a prism sheet which is provided on the diffusion sheet and is used to condense the light passing therethrough, and a protection sheet which is provided on the prism sheet to protect the prism sheet. In general, the optical sheet includes a plurality of sheets and has a thickness of about 0.5 mm.

### SUMMARY

Due to the presence of the optical sheet, the display device may have an increased thickness. Some exemplary embodiments of the inventive concept provide a display device having a reduced thickness, improved optical efficiency, and improved color reproduction characteristics.

According to some embodiments of the inventive concept, a display device includes a display module which displays an image, a light source which generates light, a light-guiding substrate which includes at least a side surface adjacent to the light source and guides the light provided from the light source toward the display module, and an optical filter provided on the light-guiding substrate. The optical filter includes a first insulating layer which includes a first sub-insulating layer in contact with a top surface of the light-guiding substrate, a second sub-insulating layer spaced apart from the top surface of the light-guiding substrate in an upward direction, and a third sub-insulating layer connecting the first sub-insulating layer to the second sub-insulating layer, a second insulating layer provided on the first insulating layer and which is in contact with the second sub-insulating layer, and a first liquid crystal layer which selectively transmits or reflects the light provided from the light-guiding substrate. The first liquid crystal layer is disposed in each of first cavities which are defined as closed spaces enclosed by the first sub-insulating layer, the third sub-insulating layer, and the second insulating layer.

In some exemplary embodiments, the first liquid crystal layer may include a plurality of first liquid crystal molecules having a first liquid crystal pitch, and each of the first liquid crystal molecules may be a cholesteric liquid crystal molecule.

In some exemplary embodiments, the first liquid crystal layer may reflect light, which is provided from the light-guiding substrate and has a wavelength within a first wavelength band, and transmit light, which is provided from the light-guiding substrate and has a wavelength out of the first wavelength band.

In some exemplary embodiments, the display module may include a retardation film provided on the optical filter and which delays a phase of one component of light passing therethrough by λ/4, where λ is a wavelength of the light, an encapsulation substrate provided on the retardation film and which faces the retardation film, and a nematic liquid crystal layer interposed between the retardation film and the encapsulation substrate.

In some exemplary embodiments, the nematic liquid crystal layer may include a plurality of nematic liquid crystal molecules.

In some exemplary embodiments, the first liquid crystal layer may further include a curable polymer material.

In some exemplary embodiments, the first insulating layer and the second insulating layer may be provided to define second cavities therebetween, the second cavities may be adjacent to the first cavities. The optical filter may further comprise a second liquid crystal layer which is disposed in each of the second cavities and may selectively transmit or reflect the light provided from the light-guiding substrate. The second liquid crystal layer may include a plurality of second liquid crystal molecules having a second liquid crystal pitch different from the first liquid crystal pitch, and each of the second liquid crystal molecules may be a cholesteric liquid crystal molecule.

In some exemplary embodiments, the second liquid crystal layer may reflect light, which is provided from the light-guiding substrate and has a wavelength within a second wavelength band, and transmit light, which is provided from the light-guiding substrate and has a wavelength out of the second wavelength band.

In some exemplary embodiments, the display module may further include a polarizing layer disposed between the encapsulation substrate and the nematic liquid crystal layer, and an optical conversion member provided between the encapsulation substrate and the polarizing layer. The optical conversion member may include a plurality of quantum dots.

In some exemplary embodiments, the display module may further include a polarizing layer provided on the encapsulation substrate.

In some exemplary embodiments, the optical filter may further include a third insulating layer which includes a fourth sub-insulating layer in contact with a top surface of the second insulating layer, a fifth sub-insulating layer spaced apart from the top surface of the second insulating layer in the upward direction, and a sixth sub-insulating layer connecting the fourth sub-insulating layer to the fifth sub-insulating layer, a fourth insulating layer provided on the third insulating layer to be in contact with the fifth sub-insulating layer, and a third liquid crystal layer which selectively transmits or reflects light provided from the first liquid crystal layer. The third liquid crystal layer may be disposed in each of third cavities, which is defined as closed spaces enclosed by the fourth sub-insulating layer, the sixth sub-insulating layer, and the fourth insulating layer.

In some exemplary embodiments, the first liquid crystal layer may include a plurality of first liquid crystal molecules having a first liquid crystal pitch, the third liquid crystal layer may include a plurality of third liquid crystal molecules having a third liquid crystal pitch different from the first liquid crystal pitch, and each of the first liquid crystal molecules and the third liquid crystal molecules may be a cholesteric liquid crystal molecule.

In some exemplary embodiments, the third liquid crystal layer may reflect light, which is provided from the first liquid crystal layer and has a wavelength within a third wavelength band, and transmit light, which is provided from the first liquid crystal layer and has a wavelength out of the third wavelength band.

In some exemplary embodiments, the first liquid crystal layer may overlap with the third liquid crystal layer in a plan view.

In some exemplary embodiments, the first liquid crystal layer may be spaced apart from the third liquid crystal layer in the plan view.

In some exemplary embodiments, the first liquid crystal layer and the third liquid crystal layer may include a plurality of first liquid crystal molecules having a first liquid crystal pitch, and each of the first liquid crystal molecules may be a cholesteric liquid crystal molecule.

In some exemplary embodiments, the third sub-insulating layer may have a cylinder shape, and a diameter of each of the first cavities in the plan view may increase in the upward direction.

In some exemplary embodiments, the display device may further include a reflecting member provided below the optical module.

According to some exemplary embodiments of the inventive concept, a display device includes a display module which displays an image and includes a retardation film which is delays a phase of one component of light passing therethrough by λ/4 (here, λ is a wavelength of the component), a light source which generates a light, a light-guiding substrate provided below the retardation film, where at least a side surface of the light-guiding substrate is provided adjacent to the light source and the light-guiding substrate guides the light provided from the light source toward the display module, and an optical filter provided on the light-guiding substrate. The optical filter includes an insulating layer which includes a first sub-insulating layer in contact with a top surface of the light-guiding substrate, a second sub-insulating layer spaced apart from the top surface of the light-guiding substrate in an upward direction, and a third sub-insulating layer connecting the first sub-insulating layer to the second sub-insulating layer, and a liquid crystal layer which selectively transmits or reflects the light provided from the light-guiding substrate. The liquid crystal layer is disposed in each of cavities which are defined as spaces enclosed by the first sub-insulating layer, the third sub-insulating layer, and the retardation film.

In some exemplary embodiments, the liquid crystal layer may include a plurality of liquid crystal molecules having a liquid crystal pitch, and each of the liquid crystal molecules may be a cholesteric liquid crystal molecule.

### BRIEF DESCRIPTION OF THE DRAWINGS

Exemplary embodiments will be more clearly understood from the following brief description taken in conjunction with the accompanying drawings. The accompanying drawings represent non-limiting, exemplary embodiments as described herein.

FIG. 1 is an exploded perspective view of an exemplary embodiment of a display device according to the inventive concept.

FIG. 2 is a cross-sectional view taken along line I-I′ of FIG. 1.

FIG. 3 is an enlarged cross-sectional view of an exemplary embodiment of the display module of FIG. 2.

FIG. 4 is an enlarged cross-sectional view of an exemplary embodiment of the optical module of FIG. 2.

FIG. 5 is an exploded perspective view of an exemplary embodiment of the optical module of FIG. 2.

FIG. 6 is a bottom plan view of an exemplary embodiment of a second insulating layer.

FIG. 7 is a top plan view of an exemplary embodiment of a light-guiding substrate.

FIG. 8 is a bottom plan view of an exemplary embodiment of a first insulating layer.

FIG. 9 is an enlarged perspective view of a region ‘A’ of FIG. 8.

FIG. 10 is an enlarged view of an exemplary embodiment of a first liquid crystal layer.

FIG. 11 is an enlarged cross-sectional view illustrating another exemplary embodiment of an optical module according to the inventive concept.

FIG. 12 is an enlarged cross-sectional view illustrating still another exemplary embodiment of a display module and an optical module according to the inventive concept.

FIG. 13 is an enlarged cross-sectional view illustrating still another exemplary embodiment of an optical module according to the inventive concept.

FIG. 14 is an enlarged cross-sectional view illustrating still another exemplary embodiment of an optical module according to the inventive concept.

FIG. 15 is an enlarged cross-sectional view illustrating another exemplary embodiment of a display module according to the inventive concept.

FIG. 16 is a cross-sectional view illustrating still another exemplary embodiment of a display device according to the inventive concept.

It should be noted that these figures are intended to illustrate the general characteristics of methods, structure and/or materials utilized in certain exemplary embodiments and to supplement the written description provided below. These drawings are not, however, to scale and may not precisely reflect the precise structural or performance characteristics of any given exemplary embodiment, and should not be interpreted as defining or limiting the range of values or properties encompassed by exemplary embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Exemplary embodiments of the inventive concept will now be described more fully with reference to the accompanying drawings, in which exemplary embodiments are shown. Exemplary embodiments of the inventive concept may, however, be embodied in many different forms and should not be construed as being limited to the exemplary embodiments set forth herein; rather, these exemplary embodiments are provided so that this disclosure will be thorough and complete, and will fully convey the concept of exemplary embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Exemplary embodiments of the inventive concept are described herein with reference to cross-sectional illustrations that are schematic illustrations of idealized exemplary embodiments (and intermediate structures) of exemplary embodiments. As such, variations from the shapes of the illustrations as a result, for example, of manufacturing techniques and/or tolerances, are to be expected. Thus, exemplary embodiments of the inventive concept should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which exemplary embodiments of the inventive concept belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

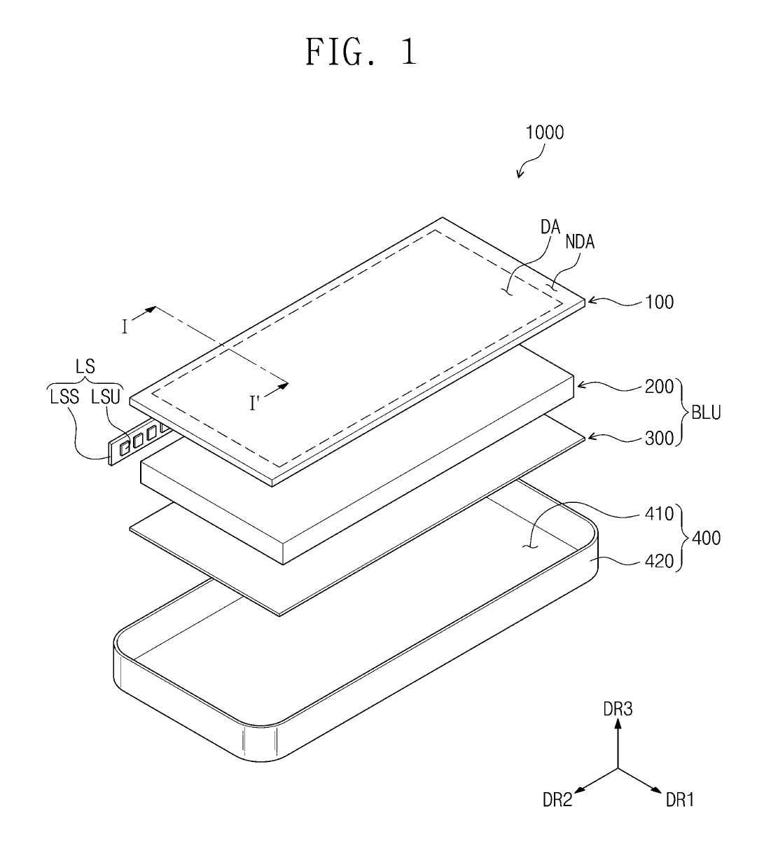

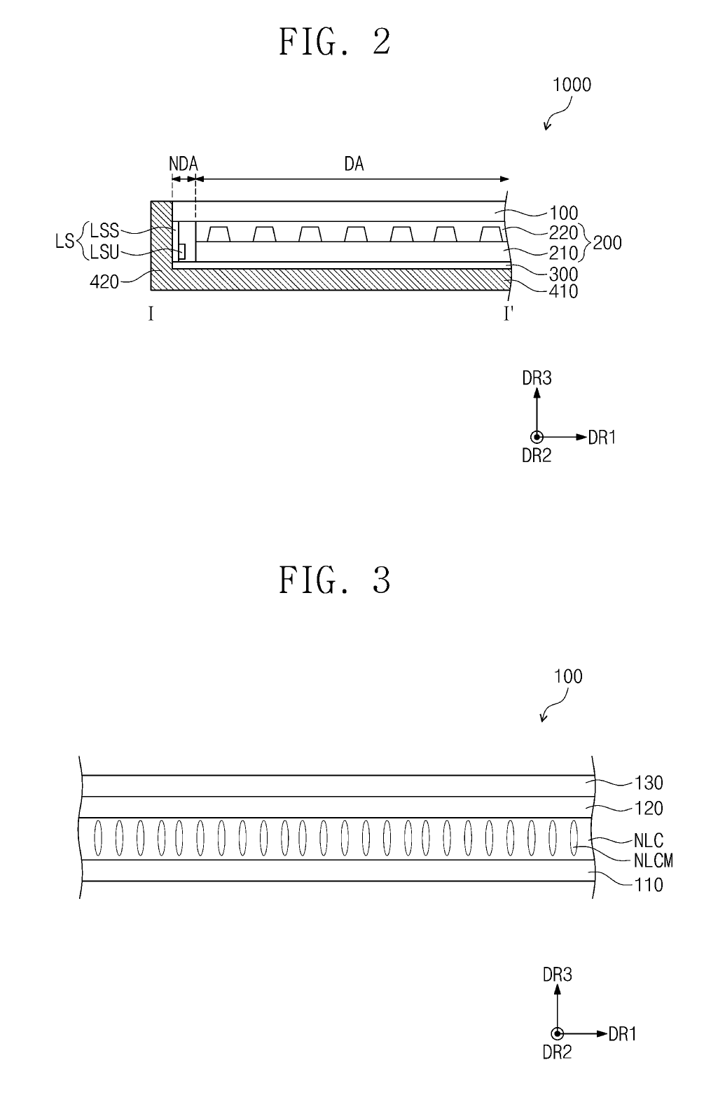

FIG. 1 is an exploded perspective view of an exemplary embodiment of a display device according to the inventive concept, and FIG. 2 is a cross-sectional view taken along line I-I′ of FIG. 1.

Referring to FIGS. 1 and 2, a display device 1000 according to the inventive concept may have a rectangular shape whose short sides are parallel to a first direction DR1 and whose long sides are parallel to a second direction DR2. However, the inventive concept is not limited to a specific shape of the display device 1000, and the display device 1000 may be provided to have various shapes.

The display device 1000 may include a display module 100, a backlight unit BLU, and a container structure 400.

For convenience in description, a propagation direction of image or light in the display device 1000 will be referred to as an upward direction, and a direction opposite to the upward direction will be referred to as a downward direction. In this exemplary embodiment, the upward and downward directions may be defined to be parallel to a third direction DR3 that is orthogonal to the first direction DR1 and the second direction DR2. Hereinafter, front and back sides of each of elements to be described below will be differentiated based on the third direction DR3. However, the directions indicated by the upward and downward directions may be relative concept, and in certain exemplary embodiments, they may be changed to indicate other directions.

The display module 100 may be configured to display an image using light provided from the backlight unit BLU.

In a plan view, the display module 100 may include a display region DA, which is used to display an image, and a non-display region NDA, which is not used to display an image. The display region DA may be disposed in a center region of the display module 100 in the plan view. The non-display region NDA may be disposed to surround the display region DA. Hereinafter, the display module 100 will be described in more detail with reference to FIG. 3.

The backlight unit BLU may be provided below the display module 100 and may be used to provide light to the display module 100. In an exemplary embodiment, the backlight unit BLU may be an edge-type backlight unit.

The backlight unit BLU may include a light source LS, an optical module 200, and a reflecting member 300.

The light source LS may be placed to face a side surface of the optical module 200 in the first direction DR1. However, the inventive concept is not limited to a specific position of the light source LS. In another exemplary embodiment, for example, the light source LS may be provided adjacent to at least one of any side surfaces of the optical module 200.

The light source LS may include a plurality of light source units LSU and a light source substrate LSS. The light source units LSU may be configured to generate a light, which will be used in the display module 100, and to provide the light to the optical module 200.

In this exemplary embodiment, the light source units LSU may be a structure including light emitting diodes (“LEDs”), each of which is provided in the form of a point light source. However, the inventive concept is not limited to the specific kind of the light source units LSU.

The inventive concept is not limited to the number of the light source units LSU. In certain exemplary embodiments, the light source unit LSU may be provided in the form of a single LED of a point light source or in the form of a plurality groups of LEDs. Furthermore, in other exemplary embodiments, the light source units LSU may be a linear light source.

The light source units LSU may be mounted on the light source substrate LSS. The light source substrate LSS may be provided to face the side surface of the optical module 200 in the first direction DR1 and may extend in the second direction DR2. Electric wires may be printed on the light source substrate LSS, and in some exemplary embodiments, the electric wires may be used to supply an electric power to the light source units LSU or to control the supply of the electric power. The light source substrate LSS may include a light source control unit (not shown), which is connected to the light source units LSU. The light source control unit may be configured to analyze an image to be displayed on the display module 100, to output a local dimming signal based on the image analysis, and to control brightness of light, which is generated by the light source units LSU, based on the local dimming signal. In certain exemplary embodiments, the light source control unit may be mounted on an additional circuit substrate, but the inventive concept is not limited to a specific position of the light source control unit.

The optical module 200 may be provided below the display module 100. The optical module 200 may include a light-guiding substrate 210 and an optical filter 220. In the optical module 200, the light-guiding substrate 210 and the optical filter 220 may be provided to have a coupled structure.

The light-guiding substrate 210 may have a plate shape. The light-guiding substrate 210 may be configured to change a propagation direction of light, which is provided from the light source LS, toward the display module 100 or in the upward direction. Although not shown in the drawings, the light-guiding substrate 210 may include a diffusion pattern (not shown), which is provided on a bottom surface of the light-guiding substrate 210.

The light source LS may be provided near a side surface of the light-guiding substrate 210 in the first direction DR1. One of side surfaces of the light-guiding substrate 210 may be positioned adjacent to the light source LS and will be referred to as an incidence surface. In addition, another one of the side surfaces of the light-guiding substrate 210 may be positioned opposite to the incidence surface and will be referred to as an opposite surface. In other words, the incidence surface is disposed at one side of the light guiding substrate 210 in the first direction and the opposite surface is disposed at other side of the light guiding substrate 210 in the first direction. However, the inventive concept is not limited to a specific position of the light source LS. In an exemplary embodiment, for example, the light source LS may be provided adjacent to at least one of any side surfaces of the optical module 210.

The light-guiding substrate 210 may be formed of or include a material having relatively high transmittance to a visible light. In an exemplary embodiment, for example, the light-guiding substrate 210 may be formed of or include glass.

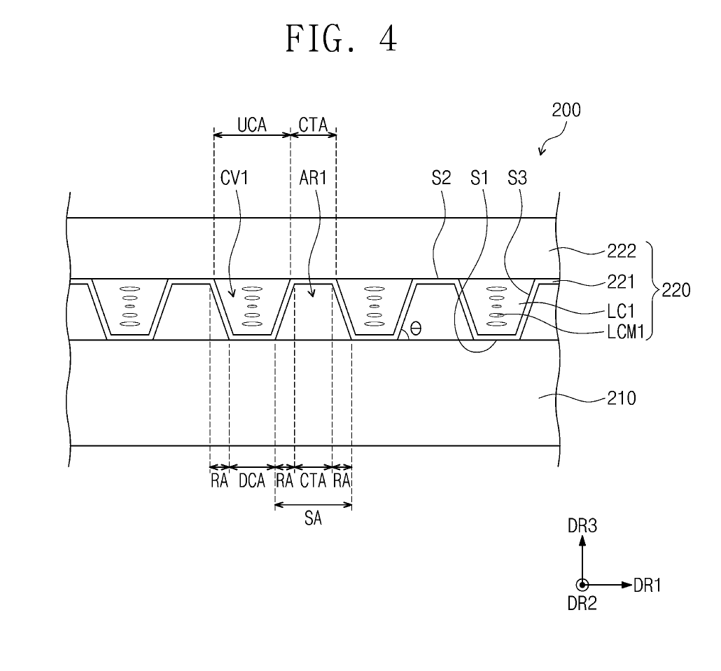

The optical filter 220 may be provided between the light-guiding substrate 210 and the display module 100. The optical filter 220 may be configured to change a propagation direction of light, which is transmitted from the light-guiding substrate 210, to the upward direction and to selectively transmit or reflect the light, which is transmitted from the light-guiding substrate 210. The light-guiding substrate 210 and the optical filter 220 will be described in more detail with reference to FIGS. 4 to 10.

Although not shown, in certain exemplary embodiments, the display device 1000 may further include a mold frame (not shown). The mold frame (not shown) may be provided on the optical module 200 (e.g., on an edge region of a top surface of the optical module 200). The mold frame (not shown) may be configured to prevent a position of the display module 100 from being unintentionally changed.

The reflecting member 300 may be provided below the light-guiding substrate 210. The reflecting member 300 may be configured to reflect a downwardly-propagating light toward the upward direction. The reflecting member 300 may be formed of or include an optically reflective material. In an exemplary embodiment, for example, the reflecting member 300 may be formed of or include aluminum.

The container structure 400 may be provided at the lowermost position of the display device 1000 and may be used to contain the backlight unit BLU. The container structure 400 may include a bottom portion 410 and a plurality of sidewall portions 420 connected to the bottom portion 410. In some exemplary embodiments, the light source LS may be provided on an inner side surface of one of the sidewall portions 420 of the container structure 400. The container structure 400 may be formed of or include a metallic material having sufficiently high hardness.

FIG. 3 is an enlarged cross-sectional view of an exemplary embodiment of the display module 100 of FIG. 2.

Referring to FIGS. 2 and 3, the display module 100 may be provided on the optical module 200 to display an image through the display region DA thereof. The display module 100 may include a light-receiving type display panel. In some exemplary embodiments, the display module 100 may include a liquid crystal display panel.

In an exemplary embodiment, for example, the display module 100 may include a first substrate 110, a second substrate 120, a polarizing layer 130, and a nematic liquid crystal layer NLC.

The first substrate 110 may be provided at the lowermost portion of the display module 100. The first substrate 110 may include or be formed of a highly transparent material, and this may make it possible to effectively transmit light, which is provided from the backlight unit BLU.

In some exemplary embodiments, the first substrate 110 may be a retardation film configured to delay the phase of one component of the light provided from the backlight unit BLU by λ/4. Thus, the first substrate 110 may be used to change a polarization state of light propagating from the backlight unit BLU to the first substrate 110. For example, when a circularly polarized light is incident on the first substrate 110 from the backlight unit BLU, the first substrate 110 may be used to convert the circularly polarized light to a linearly polarized light. The first substrate 110 may have an optic axis (not shown) that is oriented parallel to a predetermined direction. Hereinafter, the first substrate 110 will be referred to as a retardation film 110.

Although not shown, in the plan view, the first substrate 110 may include at least one-pixel region (not shown) and a non-pixel region (not shown) adjacent to the pixel region. In some exemplary embodiments, a plurality of pixel regions may be provided, and the non-pixel region may be provided between the pixel regions.

Pixels (not shown) may be provided at the pixel regions, respectively, of the first substrate 110. The pixels (not shown) may include a plurality of pixel electrodes (not shown) and a plurality of thin-film transistors (not shown) which are electrically connected to the pixel electrodes in a one-to-one manner. The thin-film transistors may be connected to the pixel electrodes, respectively, and may be used to selectively provide driving signals to pixel electrodes, respectively.

The second substrate 120 may be disposed on the first substrate 110 to face the first substrate 110. The nematic liquid crystal layer NLC may be interposed between the second substrate 120 and the first substrate 110. In an exemplary embodiment, for example, the second substrate 120 may be used as an encapsulation substrate 120 encapsulating or sealing the nematic liquid crystal layer NLC. Hereinafter, the second substrate 120 may be referred to as the encapsulation substrate 120.

The nematic liquid crystal layer NLC may include a plurality of nematic liquid crystal molecules NLCM which are oriented in a specific direction. The second substrate 120 may include a common electrode (not shown), which is used to produce an electric field for controlling the orientation or arrangement of the nematic liquid crystal molecules NLCM, in conjunction with the pixel electrodes. In the display module 100, the orientation of the nematic liquid crystal molecules NLCM in the nematic liquid crystal layer NLC may be controlled to display an image in the upward or third direction DR3.

Although not shown, a driving chip, a tape carrier package, and a printed circuit board may be provided on or in the display module 100. Here, the driving chip may be configured to generate a driving signal, the tape carrier package may be configured to allow the driving chip to be mounted thereon, and the printed circuit board may be electrically connected to the display module 100 through the tape carrier package.

The polarizing layer 130 may be provided on the second substrate 120. The polarizing layer 130 may have an absorption axis (not shown) with a predetermined direction. When a display mode of the display device 1000 is in a bright state, the polarizing layer 130 may allow the light to pass therethrough, and when the display mode of the display device 1000 is in a dark state, the polarizing layer 130 may absorb the light.

An angle between the optic axis of the first substrate 110 and the absorption axis of the polarizing layer 130 may be changed depending on an orientation mode of the nematic liquid crystal molecules NLCM. In an exemplary embodiment, for example, the optic axis of the first substrate 110 may be orthogonal to the absorption axis of the polarizing layer 130 in the plan view.

Hereinafter, the optical module 200 will be described in more detail with reference to FIGS. 4 to 9.

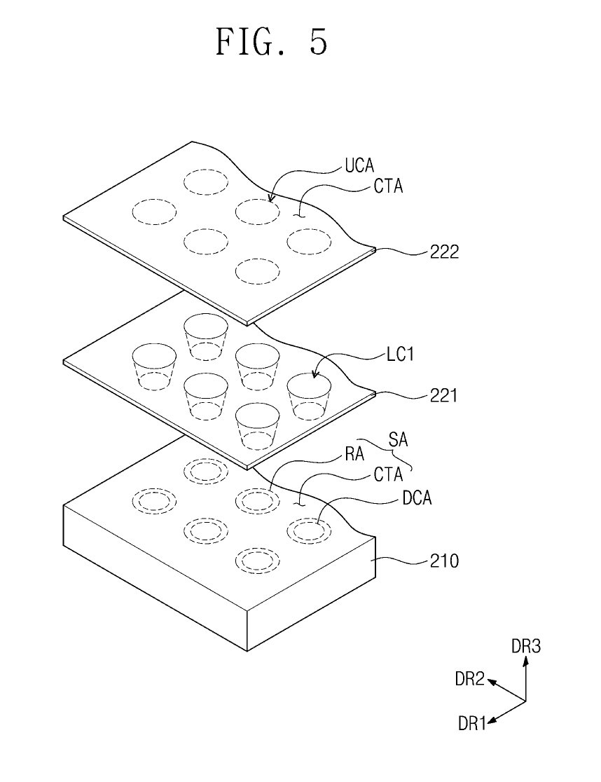

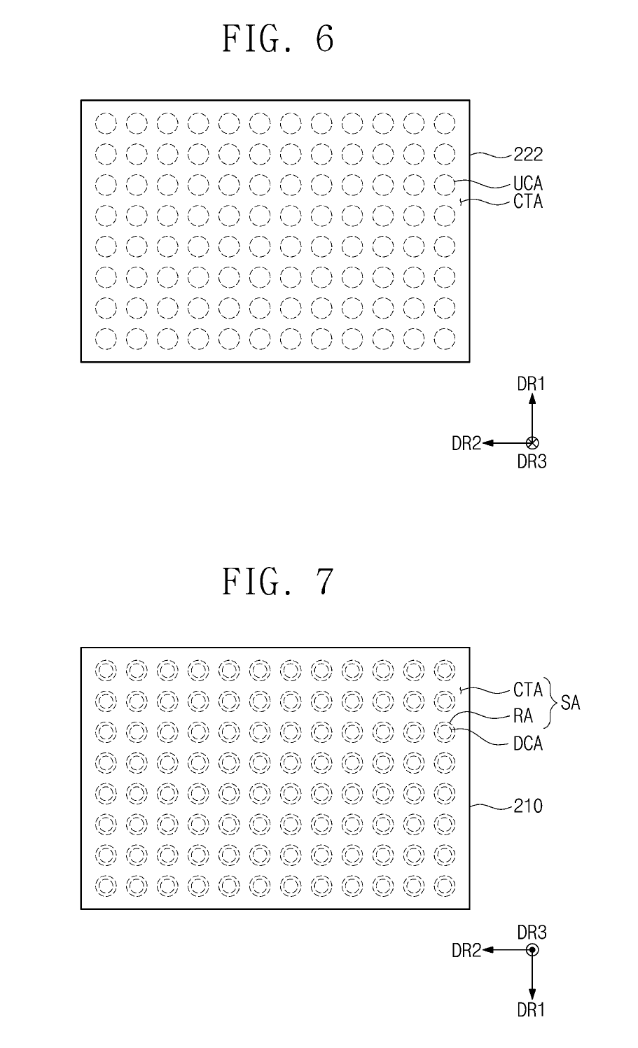

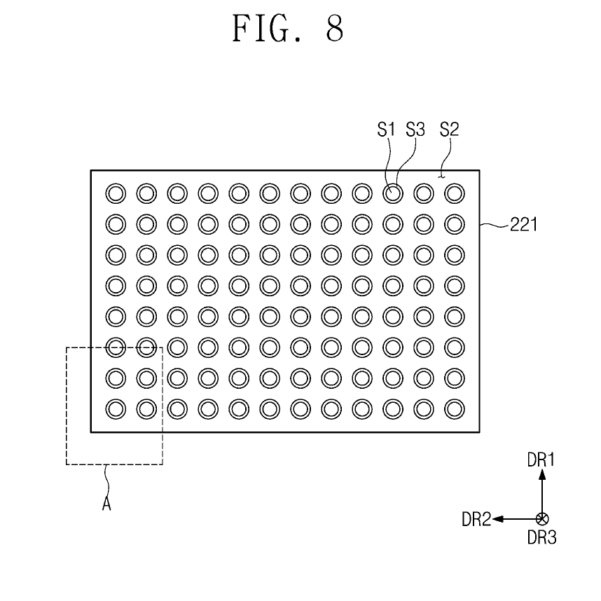

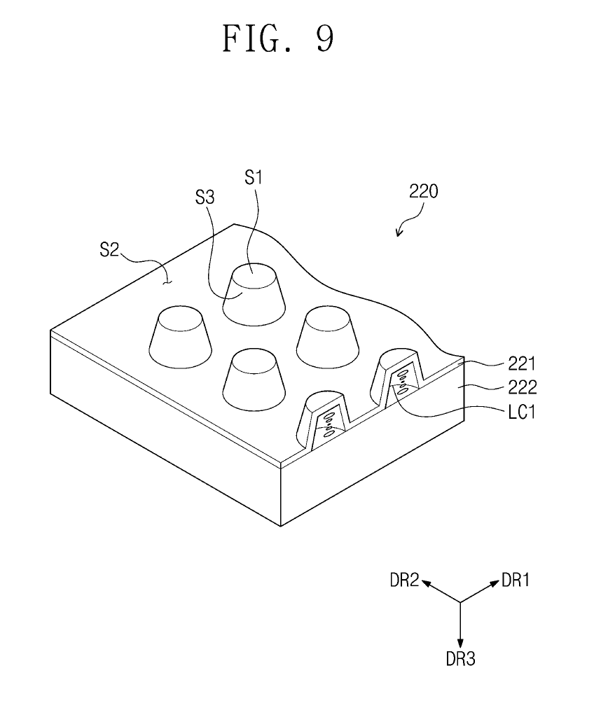

FIG. 4 is an enlarged cross-sectional view of an exemplary embodiment of the optical module 200 of FIG. 2, and FIG. 5 is an exploded perspective view of an exemplary embodiment of the optical module 200. FIG. 6 is a bottom plan view of an exemplary embodiment of the second insulating layer 222, and FIG. 7 is a top plan view of an exemplary embodiment of the light-guiding substrate 210. FIG. 8 is a bottom plan view of an exemplary embodiment of the first insulating layer 221, and FIG. 9 is an enlarged perspective view of a region ‘A’ of FIG. 8, and is a bottom perspective view of the first insulating layer 221.

Referring to FIGS. 4, 5, 7, and 9, the optical module 200, according to some exemplary embodiments of the inventive concept, may have a structure in which the light-guiding substrate 210 and the optical filter 220 are coupled to each other.

In the plan view, the light-guiding substrate 210 may include a plurality of downside central regions DCA and a peripheral region SA. In an exemplary embodiment, each of the downside central regions DCA may have a circular shape. The peripheral region SA may be defined as a region which surrounds the downside central region DCA. In an exemplary embodiment, for example, in the plan view, the peripheral region SA may include a plurality of ring-shaped regions RA and a contact region CTA which is not overlapped with the ring-shaped regions RA. Each of the ring-shaped regions RA may be defined as a region which surrounds a corresponding one of the downside central regions DCA with a ring shape.

In an exemplary embodiment, the light-guiding substrate 210 may have a first refractive index n1. In an exemplary embodiment, for example, in the case where the light-guiding substrate 210 includes a glass material, the first refractive index n1 may range from 1.2 to 1.7.

The optical filter 220 may include a first insulating layer 221, a second insulating layer 222, and a first liquid crystal layer LC1. The first insulating layer 221 may be provided on the light-guiding substrate 210. The first insulating layer 221 may have a single-body structure in the plan view.

The first insulating layer 221 may have a refractive index higher than or equal to that of the light-guiding substrate 210. In other words, the first insulating layer 221 may have a second refractive index n2 that is greater than or equal to the first refractive index n1. In an exemplary embodiment, for example, the second refractive index n2 may range from 1.5 to 1.8. In some exemplary embodiments, the first insulating layer 221 may be formed of or include silicon nitride (SiNx).

As shown in FIG. 6, the second insulating layer 222 may be provided on the first insulating layer 221. In an exemplary embodiment, the second insulating layer 222 may have substantially the same refractive index as that of the light-guiding substrate 210. In other words, the second insulating layer 222 may have the first refractive index n1. In an exemplary embodiment, for example, the second insulating layer 222 may be formed of or include an organic material.

In this exemplary embodiment, the second insulating layer 222 may have the first refractive index n1, but the inventive concept is not limited thereto. For example, in other exemplary embodiments, the second insulating layer 222 may have a refractive index that is not equal to the first refractive index n1 and is less than the second refractive index n2.

In the plan view, the second insulating layer 222 may include a plurality of upside central regions UCA. A diameter of each of the upside central regions UCA may be larger than that of each of the downside central regions DCA. For example, in the plan view, each of the upside central regions UCA and the corresponding downside central region DCA and ring-shaped region RA may overlap in their entirety. In other words, the second insulating layer 222 may be in contact with the first insulating layer 221 in the contact region CTA, except for the upside central regions UCA.

As shown in FIGS. 4 and 8, the first insulating layer 221 may include a first sub-insulating layer S1, a second sub-insulating layer S2, and a third sub-insulating layer S3. The first sub-insulating layer S1, the second sub-insulating layer S2 and the third sub-insulating layer S3 may be connected to each other to have a single-body structure.

The first sub-insulating layer S1 may overlap with the downside central region DCA and may be in contact with a top surface of the light-guiding substrate 210. The second sub-insulating layer S2 may overlap with the contact region CTA, may be spaced apart from the top surface of the light-guiding substrate 210 in the upward direction (e.g., the third direction DR3), and may be in contact with a bottom surface of the second insulating layer 222. The third sub-insulating layer S3 may overlap with the ring-shaped region RA in the plan view, and may connect the first sub-insulating layer S1 and the second sub-insulating layer S2 to each other. The third sub-insulating layer S3 may be provided to have a cylindrical shape. The first sub-insulating layer S1 may not overlap with the second sub-insulating layer S2 in the plan view.

In some exemplary embodiments, a plurality of first cavities CV1 may be defined as closed spaces between the first insulating layer 221 and the second insulating layer 222. Each of the first cavities CV1 may be a closed space that is confined by the first sub-insulating layer S1, the third sub-insulating layer S3, and the bottom surface of the second insulating layer 222. The first cavities CV1 may be enclosed by a first space AR1 in a cross-sectional view.

In some exemplary embodiments, since the downside central region DCA provided with the first sub-insulating layer S1 has a smaller area than that of the upside central region UCA, a top area of the first cavity CV1 may be larger than a bottom area of the first cavity CV1. Accordingly, the third sub-insulating layer S3 defining the first cavity CV1 may have an inclined surface. In other words, the third sub-insulating layer S3 may be shaped like a hollow cylinder having an increasing diameter in the upward direction.

In some exemplary embodiments, the third sub-insulating layer S3 may be inclined at an angle θ of about 55° to 65° with respect to the top surface of the light-guiding substrate 210. For example, the angle θ between the third sub-insulating layer S3 and the top surface of the light-guiding substrate 210 may be about 60°.

The first liquid crystal layer LC1 may be placed in each of the first cavities CV1. The first liquid crystal layer LC1 may include a plurality of first liquid crystal molecules LCM1. In an exemplary embodiment, the first liquid crystal molecules LCM1 may be cholesteric liquid crystal molecules.

The first liquid crystal layer LC1 may further include a curable polymer. In an exemplary embodiment, a refractive index of the first liquid crystal layer LC1 may be the same as that of the light-guiding substrate 210. In other words, the first liquid crystal layer LC1 may have the first refractive index n1. Accordingly, light provided to the light-guiding substrate 210 may be incident on the first liquid crystal layer LC1 and propagate to the second insulating layer 222. The light, which is incident on the first liquid crystal layer LC1, may be reflected by the third sub-insulating layer S3 and may propagate in the upward direction.

In this exemplary embodiment, the first liquid crystal layer LC1 having the first refractive index n1 is described, but the inventive concept is not limited thereto. For example, in other exemplary embodiments, the first liquid crystal layer LC1 may have a refractive index that is different from the first refractive index n1 and is smaller than that of the second refractive index n2.

The first space AR1 may have a refractive index that is smaller than that of the light-guiding substrate 210. For example, the first space AR1 may have a third refractive index n3 that is smaller than the first refractive index n1. In some exemplary embodiments, the first space AR1 may be an air gap, and in this case, the third refractive index n3 may be about 1.0. In such a case, light provided to the light-guiding substrate 210 may be reflected on a surface, adjacent to the light-guiding substrate 210, of the first space AR1, and therefore may not be provided to the first space AR1.

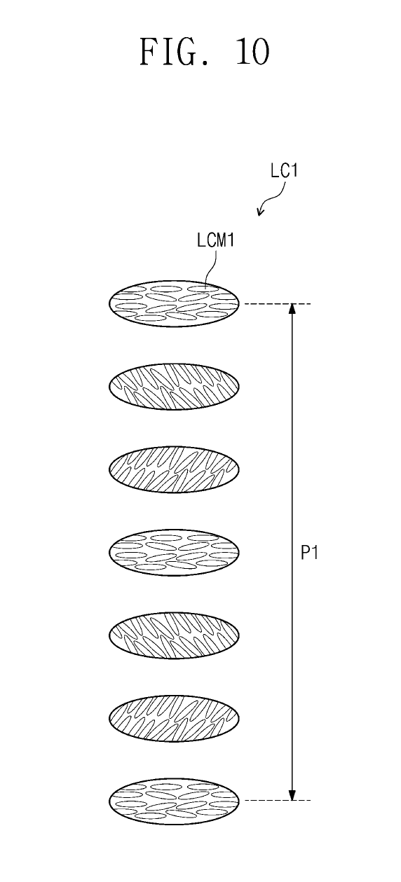

FIG. 10 is an enlarged view of an exemplary embodiment of a first liquid crystal layer LC1.

Referring further to FIG. 10, the first liquid crystal molecules LCM1 of the first liquid crystal layer LC1 may have a spiral structure that is repeatedly twisted with a specific liquid crystal pitch. The first liquid crystal molecules LCM1 may have a first liquid crystal pitch P1.

The optical filter 220 may be configured to selectively transmit or reflect light provided to the optical filter 220. In an exemplary embodiment, for example, the first liquid crystal molecules LCM1 of the first liquid crystal layer LC1 may reflect light whose center wavelength is equal to the first liquid crystal pitch P1, among the light incident on the first liquid crystal layer LC1. In other words, in an exemplary embodiment, the first liquid crystal molecules LCM1 may be provided to reflect light having a first wavelength band and to transmit light whose wavelength is out of the first wavelength band. In an exemplary embodiment, a band width of the first wavelength band may be controlled by birefringence, curable polymer content, and so forth.

The first liquid crystal layer LC1 may be configured to change a polarization state of light passing therethrough. For example, if an unpolarized light passes through the first liquid crystal layer LC1, the unpolarized light may be changed to a circularly polarized light. The circularly polarized light may be changed to a linearly polarized light by the retardation film 110.

According to some exemplary embodiments of the inventive concept, since the first insulating layer 221 of the optical filter 220 is partially in contact with the light-guiding substrate 210 or the second insulating layer 222, the plurality of the first cavities CV1 may be formed therebetween, and this may make it possible to improve light-concentration efficiency of the display device 1000.

Also, since the first liquid crystal layer LC1 disposed in the plurality of cavities CV1 is configured to selectively transmit and reflect light incident on the optical filter 220, it may be possible to improve color reproduction characteristics of a display device.

In addition, since the optical module 200 is used to replace a conventional light guide plate, a prism sheet, and a lower polarization plate, a thickness of the display device 1000 may be reduced.

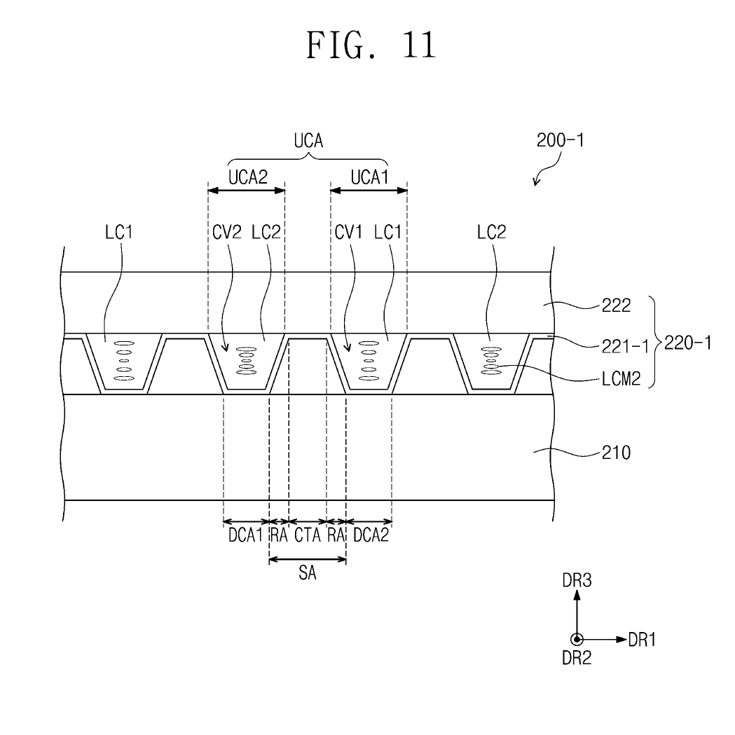

FIG. 11 is an enlarged cross-sectional view illustrating another exemplary embodiment of an optical module according to the inventive concept. In the following description of FIG. 11, previously described elements may be identified by similar or identical reference numbers without repeating an overlapping description thereof, for the sake of brevity.

Referring to FIG. 11, the upside central region UCA of the second insulating layer 222 may include a first central region UCA1 and a second central region UCA2. The first central region UCA1 may be adjacent to the second central region UCA2.

In an exemplary embodiment, first cavities CV1 and second cavities CV2 may be defined as closed spaces between the first insulating layer 221-1 and the second insulating layer 222. In the plan view, the first cavities CV1 may overlap with the first central region UCA1, and the second cavities CV2 may overlap with the second central region UCA2. The areas of the first central region UCA1 and the second central region UCA2 may be different from each other, and the areas of each of the first cavities CV1 and each of the second cavities CV2 may be different from each other.

In an exemplary embodiment, the optical filter 220-1 may be configured to further include a second liquid crystal layer LC2. The first liquid crystal layer LC1 may be placed in each of the first cavities CV1, and the second liquid crystal layer LC2 may be placed in each of the second cavities CV2.

The second liquid crystal layer LC2 may include a plurality of second liquid crystal molecules LCM2. In an exemplary embodiment, the second liquid crystal molecules LCM2 may be cholesteric liquid crystal molecules. The second liquid crystal molecules LCM2 may be provided to have a second liquid crystal pitch (not shown). The second liquid crystal pitch may be different from the first liquid crystal pitch P1.

The second liquid crystal molecules LCM2 may be provided to reflect light having a second wavelength band and to transmit light whose wavelength is out of the second wavelength band. In an exemplary embodiment, the center wavelength of the second wavelength band may be substantially equal to the second liquid crystal pitch P2.

In the present exemplary embodiments, the upside central region UCA is described to have two kinds of the central regions UCA1 and UCA2, but the inventive concept is not limited to the number of kinds of the central regions UCA1 and UCA2 included in the upside central region UCA. For example, in certain exemplary embodiments, the upside central region UCA may include three or more different kinds of central regions, in which different liquid crystal layers with different liquid crystal pitches are provided.

In certain exemplary embodiments, the upside central region UCA may entirely overlap with a pixel region (not shown) defined in the first substrate 110. Furthermore, each of the first and second central regions UCA1 and UCA2 may entirely overlap with a corresponding one of sub-pixel regions (not shown) defined in the retardation film 110. In this case, light propagating upwardly from the first and second liquid crystal layer LC1 and LC2 may be provided to a corresponding one of the pixel regions.

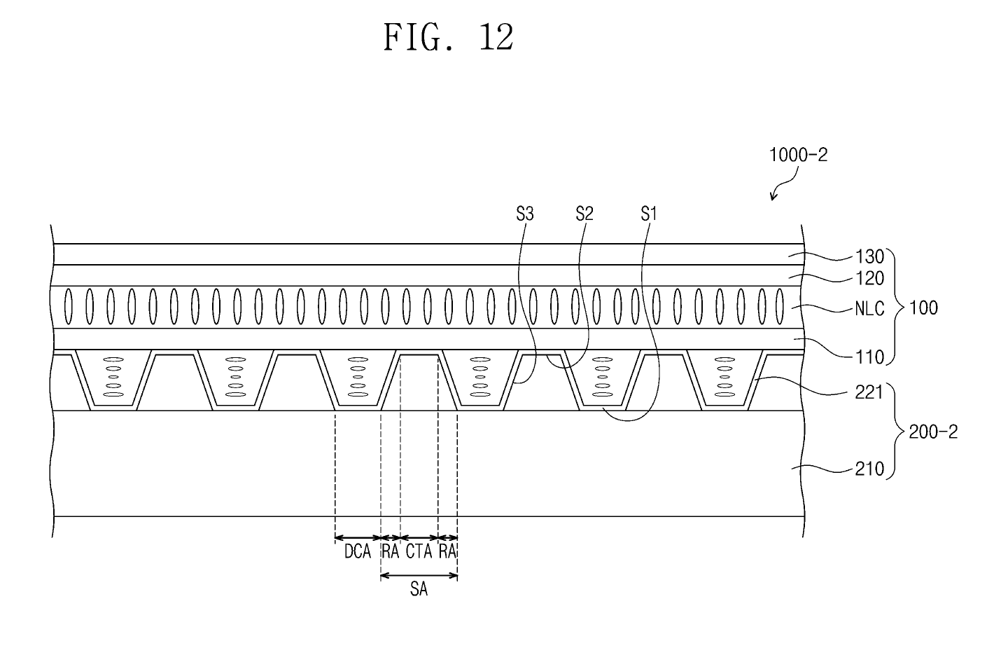

FIG. 12 is an enlarged cross-sectional view illustrating still another exemplary embodiment of an optical module according to the inventive concept. In the following description of FIG. 12, previously described elements may be identified by similar or identical reference numbers without repeating an overlapping description thereof, for the sake of brevity.

Referring to FIG. 12, an optical module 200-2 according to another exemplary embodiment of the inventive concept may not have the second insulating layer 222. In this case, the second sub-insulating layer S2 of the first insulating layer 221 may overlap with the contact region CTA and may be in contact with the bottom surface of the retardation film 110.

In this exemplary embodiment, since the second insulating layer 222 is not provided, the display device 1000 may have a reduced thickness.

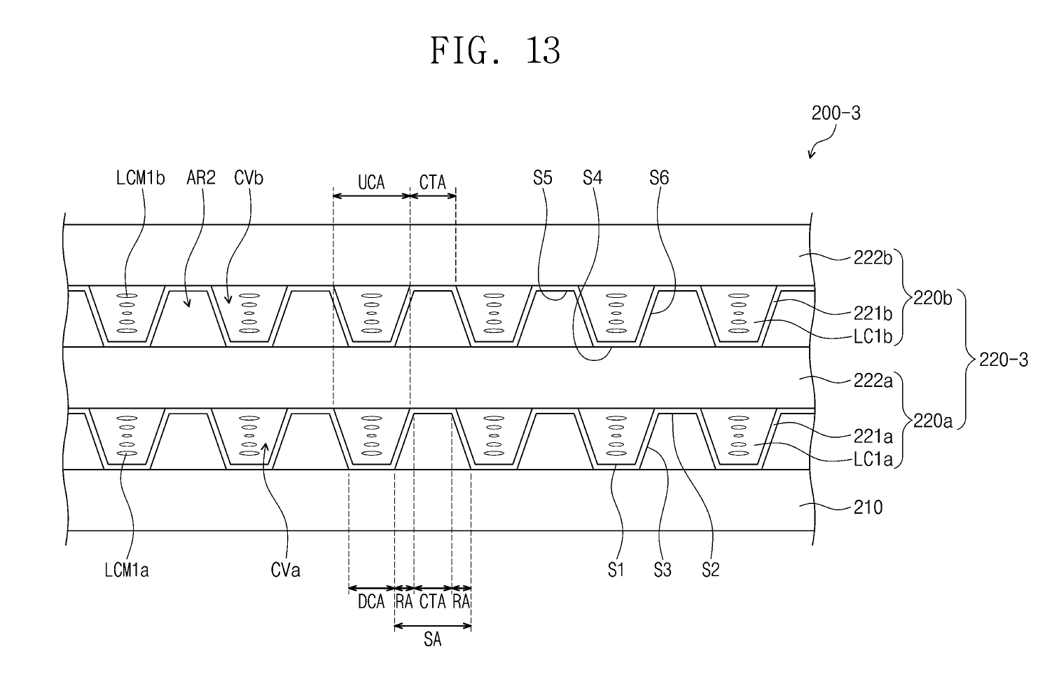

FIG. 13 is an enlarged cross-sectional view illustrating still another exemplary embodiment of an optical module 200-3 according to the inventive concept. In the following description of FIG. 13, previously described elements may be identified by similar or identical reference numbers without repeating an overlapping description thereof (e.g., first insulating layer 221a), for the sake of brevity.

Referring to FIG. 13, an optical filter 220-3, according to still another exemplary embodiment of the inventive concept, may include a first optical filter unit 220a and a second optical filter unit 220b. The first optical filter unit 220a may be configured to have substantially the same features as those of the optical filter 220 described with reference to FIG. 4, and thus, a detailed description thereof will be omitted.

The second optical filter unit 220b may include a third insulating layer 221b, a fourth insulating layer 222b, and a third liquid crystal layer LC1b. The third insulating layer 221b may be provided on a second insulating layer 222a of the first optical filter unit 220a. The third insulating layer 221b may have a single-body structure in the plan view. The third insulating layer 221b may have the second refractive index n2. In an exemplary embodiment, for example, the third insulating layer 221b may be formed of or include silicon nitride (SiNx).

The third insulating layer 221b may include a fourth sub-insulating layer S4, a fifth sub-insulating layer S5, and a sixth sub-insulating layer S6. The fourth sub-insulating layer S4, the fifth sub-insulating layer S5, and the sixth sub-insulating layer S6 may be connected to each other to have a single-body structure.

The fourth sub-insulating layer S4 may overlap with the downside central region DCA and may be in contact with the top surface of the second insulating layer 222a. The fifth sub-insulating layer S5 may overlap with the contact region CTA, may be spaced apart from the top surface of the second insulating layer 222a in the upward direction, and may be in contact with a bottom surface of the fourth insulating layer 222b. The sixth sub-insulating layer S6 may overlap with the ring-shaped region RA in the plan view, and may connect the fourth sub-insulating layer S4 and the fifth sub-insulating layer S5 to each other. The sixth sub-insulating layer S6 may be provided to have a cylindrical shape.

In an exemplary embodiment, a plurality of third cavities CVb may be defined as closed spaces between the third insulating layer 221b and the fourth insulating layer 222b. Each of the third cavities CVb may be a closed space that is confined by the fourth sub-insulating layer S4, the sixth sub-insulating layer S6, and the bottom surface of the fourth insulating layer 222b. The third cavities CVb may be enclosed by a second space AR2 in a cross-sectional view.

The third liquid crystal layer LC1b may be placed in each of the third cavities CVb. The third liquid crystal layer LC may overlap with the first liquid crystal layer LC1a, in the plan view.

The third liquid crystal layer LC1b may include a plurality of third liquid crystal molecules LCMlb. In an exemplary embodiment, the third liquid crystal molecules LCMlb may be cholesteric liquid crystal molecules. The third liquid crystal molecules LCM1b of the third liquid crystal layer LC1b may have a spiral structure that is repeatedly twisted with a specific liquid crystal pitch. The third liquid crystal molecules LCM1b may have a third liquid crystal pitch P3.

The third liquid crystal pitch P3 may be different from the first liquid crystal pitch P1. The third liquid crystal molecules LCM1b may be provided to reflect light having a third wavelength band and to transmit light whose wavelength is out of the third wavelength band. In an exemplary embodiment, the center wavelength of the third wavelength band may be substantially equal to the third liquid crystal pitch P3.

In the case where the third liquid crystal pitch P3 is smaller than the first liquid crystal pitch P1, a wavelength of light reflected by the third liquid crystal layer LC1b may be less than a wavelength of light reflected by the first liquid crystal layer LC1a. For example, in the case where the first wavelength band of which light is reflected by the first liquid crystal layer LCla overlaps with a wavelength band of red light and the third wavelength band of which light is reflected by the third liquid crystal layer LC1b overlaps with a wavelength band of green light, red light of light incident on the optical filter 220-3 may be reflected by the first liquid crystal layer LC1a, and green and blue lights may transmit through the first liquid crystal layer LCla and may be provided to the third liquid crystal layer LC1b. In addition, the green light incident on the third liquid crystal layer LC1b may be reflected by the third liquid crystal layer LC1b, and therefore only the blue light may transmit through the third liquid crystal layer LC1b.

In some exemplary embodiments, a twisting direction of the third liquid crystal molecules LCM1b of the third liquid crystal layer LC1b may be different from that of first liquid crystal molecules LCMla of the first liquid crystal layer LC1a. For example, in the case where the third liquid crystal molecules LCM1b have a spiral structure that is twisted in a clockwise direction, the first liquid crystal molecules LCM1a may have a spiral structure that is twisted in a counterclockwise direction.

In this exemplary embodiment, the optical filter 220-3 having only the first optical filter unit 220a and the second optical filter unit 220b is described. However, the inventive concept is not limited to the number of optical filter units included in the optical filter 220-3. In certain exemplary embodiments, the optical filter 220-3 may be configured to include three or more optical filter units.

Although not shown, in an exemplary embodiment, the retardation film 110 of the display module 100 may be omitted, depending on the number of stacked optical filter units. In an exemplary embodiment, for example, in the case where the number of optical filter units in the optical filter 220-3 is even, the retardation film 110 may be omitted. In such a case, pixels (not shown) may be provided on an additional glass substrate, which is provided instead of retardation film, or may be directly provided on a top surface of the optical filter 220-3. According to the above exemplary embodiments of the inventive concept, it may be possible to improve color reproduction characteristics of a display device.

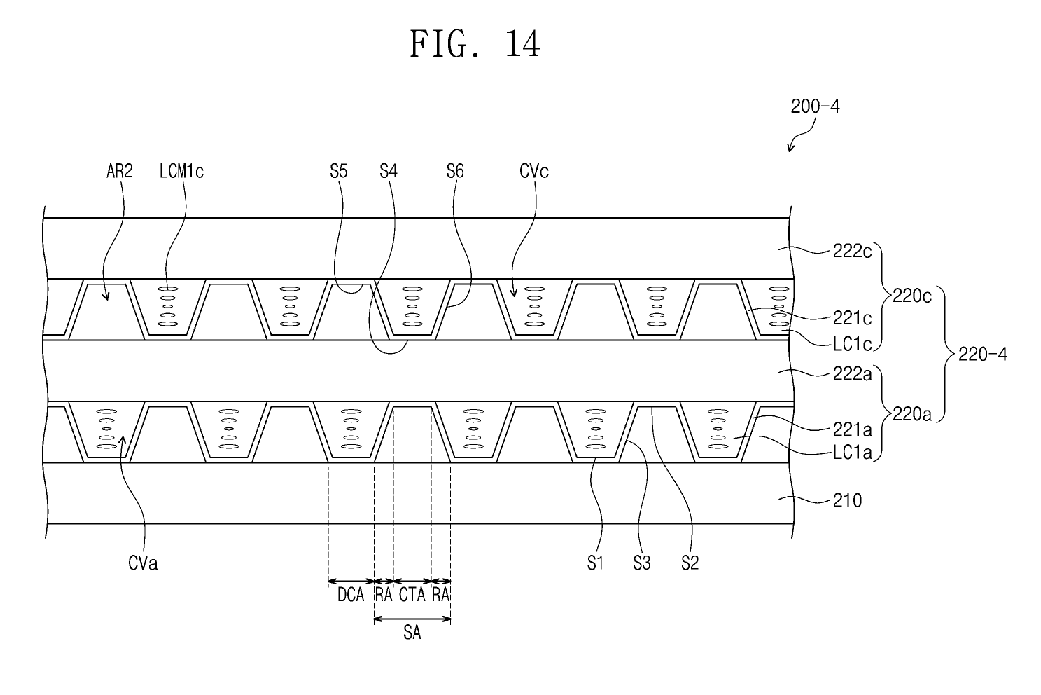

FIG. 14 is an enlarged cross-sectional view illustrating still another exemplary embodiment of an optical module 200-4 according to the inventive concept. In the following description of FIG. 14, previously described elements may be identified by similar or identical reference numbers without repeating an overlapping description thereof, for the sake of brevity.

Referring to FIG. 14, an optical filter 220-4 according to still another exemplary embodiment of the inventive concept may include a first optical filter unit 220a and a second optical filter unit 220c. The first optical filter unit 220a may be configured to have substantially the same features as those of the optical filter 220 described with reference to FIG. 4, and thus, a detailed description thereof will be omitted.

The second optical filter unit 220c may include a third insulating layer 221c, a fourth insulating layer 222c, and a third liquid crystal layer LC1c. The third insulating layer 221c may include the fourth sub-insulating layer S4, the fifth sub-insulating layer S5, and the sixth sub-insulating layer S6. The fourth sub-insulating layer S4, the fifth sub-insulating layer S5, and the sixth sub-insulating layer S6 may be connected to each other to have a single-body structure.

The fourth sub-insulating layer S4 may overlap with the contact region CTA and may be in contact with the top surface of the second insulating layer 222a. The fifth sub-insulating layer S5 may overlap with the downside central region DCA, may be spaced apart from the top surface of the second insulating layer 222a in the upward direction, and may be in contact with the bottom surface of the fourth insulating layer 222c. The sixth sub-insulating layer S6 may overlap with the ring-shaped region RA in the plan view, and may connect the fourth sub-insulating layer S4 and the fifth sub-insulating layer S5 to each other. The sixth sub-insulating layer S6 may be provided to have a cylindrical shape.

In the present exemplary embodiments, a plurality of third cavities CVc may be defined as closed spaces between the third insulating layer 221c and the fourth insulating layer 222c. Each of the third cavities CVc may be a closed space that is confined by the fourth sub-insulating layer S4, the sixth sub-insulating layer S6, and the bottom surface of the fourth insulating layer 222c. The third cavities CVc may be enclosed by a third space AR3 in a cross-sectional view.

The third liquid crystal layer LC1c may be placed in each of the third cavities CVc. The third liquid crystal layer LC1c may not overlap with the first liquid crystal layer LCla in the plan view.

The third liquid crystal layer LC1c may include a plurality of third liquid crystal molecules LCM1c. In an exemplary embodiment, the third liquid crystal molecules LCM1c may be cholesteric liquid crystal molecules. The third liquid crystal molecules LCM1c of the third liquid crystal layer LC may have a spiral structure that is repeatedly twisted with a specific liquid crystal pitch. The third liquid crystal molecules LCM1c may have the third liquid crystal pitch P3-1.

The third liquid crystal pitch P3-1 may be different from the first liquid crystal pitch P1. The third liquid crystal molecules LCM1c may be provided to reflect light having a third wavelength band and to transmit light whose wavelength is out of the third wavelength band. In an exemplary embodiment, the center wavelength of the third wavelength band may be substantially equal to the third liquid crystal pitch P3-1.

However, the inventive concept is not limited thereto. In certain exemplary embodiments, the third liquid crystal layer LC1c may include a plurality of third liquid crystal molecules LCM1c which are provided to have the same liquid crystal pitch with a first liquid crystal pitch of the first liquid crystal molecules LCM1a. For example, the second liquid crystal layer LC1c may be provided to include the same liquid crystal molecules as those in the first liquid crystal layer LC1a.

In this exemplary embodiment, since, in the plan view, the first liquid crystal layer LC1a and the third liquid crystal layer LC1c do not overlap with each other, it may be possible to reduce or minimize transmission loss of light transmitting through the first liquid crystal layer LC1a. In other words, it may be possible to improve optical efficiency of the display device.

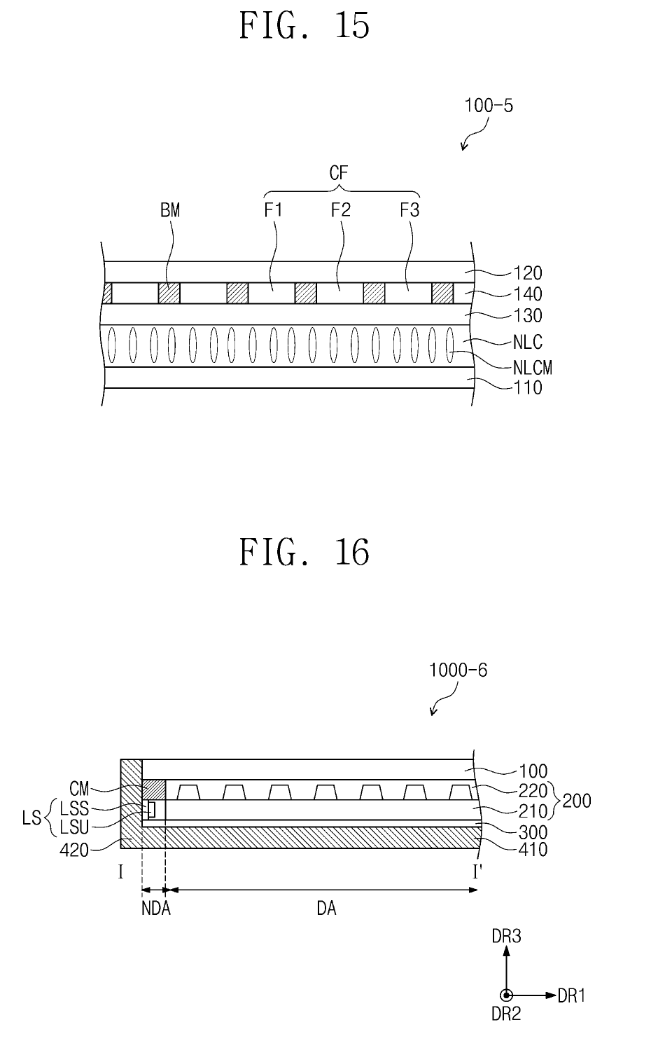

FIG. 15 is an enlarged cross-sectional view illustrating another exemplary embodiment of a display module 100-5 according to the inventive concept. In the following description of FIG. 15, previously described elements may be identified by similar or identical reference numbers without repeating an overlapping description thereof, for the sake of brevity.

Referring to FIG. 15, a display module 100-5 according to another exemplary embodiment of the inventive concept may further include an optical conversion member 140. The optical conversion member 140 may be provided between the nematic liquid crystal layer NLC and the second substrate 120.

The optical conversion member 140 may include a plurality of conversion filters CF and a black matrix BM.

The conversion filters CF may be configured to change color of light incident on the optical conversion member 140 or transmit the light without a change in color, depending on energy of the light. Light generated by the light source LS may be converted into various colors of lights by the optical conversion member 140, and this conversion may be used to display a color image.

The conversion filters CF may include a plurality of light conversion particles. Each of the light conversion particles may be configured to absorb at least a portion of an incident light and then to emit a specific color of light or transmit the portion of the incident light without a change in color. In the case where the energy of the light incident on the conversion filter CF is high enough to excite the light conversion particle, the light conversion particle may absorb at least a portion of the incident light, thereby being in an excited state, and then, may emit a specific color of light, when it is returned to a stable or low-energy state. By contrast, in the case where the energy of the incident light is too low to excite the light conversion particle, the incident light may pass through the conversion filter CF without a change in color and may be recognized from the outside.

The color of light emitted from the light conversion particle may be determined by a particle size of the light conversion particle. In general, the larger the particle size is, the longer the wavelength of the emitted light is, and the smaller the particle size is, the shorter the wavelength of the emitted light is. In an exemplary embodiment, the light conversion particle may be or include a quantum dot (“QD”).

The light emitted from the conversion filter CF may propagate in various directions. For example, a portion of the light, which is emitted from the conversion filter CF, may propagate toward the second substrate 120 and the black matrix BM.

In an exemplary embodiment, the conversion filters CF may include a first conversion filter F1, a second conversion filter F2, and a third conversion filter F3. The black matrix BM may be disposed between the first, second, and third conversion filters F1, F2, and F3 and define a border of each of the first, second, and third conversion filters F1, F2, and F3.

The first conversion filter F1 and the second conversion filter F2 may be configured to convert the light incident on the optical conversion member 140 to lights having different wavelength bands, respectively.

In an exemplary embodiment, for example, the first conversion filter F1 may be configured to substantially convert a blue light to a green light. The second conversion filter F2 may be configured to substantially convert a blue light to a red light. The third conversion filter F3 may be a colorless filter or a gray filter. In the case where a blue light is incident on the optical conversion member 140 through the optical filter 220, the third conversion filter F3 may not lead to a change in color of the incident light, and thus, the third conversion filter F3 may emit the blue light. Here, the third conversion filter F3 may be configured to allow at least a portion of light incident on the third conversion filter F3 to pass therethrough, and if this condition is satisfied, the inventive concept is not limited to a specific material of the third conversion filter F3.

As described above, the wavelength of the converted light may be determined by a particle size of the quantum dot. Accordingly, the second conversion filter F2 may include a quantum dot having the largest particle size, and the third conversion filter F3 may include a quantum dot having the smallest particle size. In certain exemplary embodiments, the third conversion filter F3 may be configured not to include any quantum dot.

The black matrix BM may be provided adjacent to the conversion filters CF. In an exemplary embodiment, the black matrix BM may be formed of or include a light blocking material. The black matrix BM may have a shape corresponding to that of a peripheral region (not shown). The black matrix BM may be configured to prevent light from being leaked through any other region, except for a pixel region (not shown) that is used to display an image, or to prevent a light leakage phenomenon from occurring. That is, the black matrix BM may also be configured to clarify boundaries between adjacent ones of the pixel regions.

In an exemplary embodiment referring to FIG. 15, the polarizing layer 130 may be provided between the nematic liquid crystal layer NLC and the optical conversion member 140. In other words, the polarizing layer 130 may be provided below the second substrate 120, not on the second substrate 120.

FIG. 16 is a cross-sectional view illustrating still another exemplary embodiment of a display device 1000-6 according to the inventive concept. In the following description of FIG. 16, previously described elements may be identified by similar or identical reference numbers without repeating an overlapping description thereof, for the sake of brevity.

A display device 1000-6 according to still another exemplary embodiment of the inventive concept may further include a light-blocking member CM.

The light-blocking member CM may be placed to face a side surface of the optical filter 220 in the first direction DR1. The light-blocking member CM may be provided on the light source LS. In an exemplary embodiment, for example, in the case where the light source LS extends in the second direction DR2, the light-blocking member CM may have a shape extending along the light source LS or in the second direction DR2.

The light-blocking member CM may be configured to block light which is not incident on the light-guiding substrate 210 from the light source LS and directly propagates toward the side surface of the optical filter 220. The optical filter 220 may be formed of or include at least one of materials capable of absorbing or reflecting light.

Thus, in this exemplary embodiment, it may be possible to increase brightness uniformity of the display device 1000-6.

According to some exemplary embodiments of the inventive concept, it may be possible to reduce a thickness of a display device and to improve optical efficiency and color reproduction characteristics of the display device.

While exemplary embodiments of the inventive concept have been particularly shown and described, it will be understood by one of ordinary skill in the art that variations in form and detail may be made therein without departing from the spirit and scope of the attached claims.

What is claimed is:

1. A display device, comprising:
a display module which displays an image;
a light source which generates light;
a light-guiding substrate which includes at least a side surface adjacent to the light source and guides the light provided from the light source toward the display module; and
an optical filter provided on the light-guiding substrate,
wherein the optical filter comprises:
a first insulating layer which includes a first sub-insulating layer in contact with a top surface of the light-guiding substrate, a second sub-insulating layer spaced apart from the top surface of the light-guiding substrate in an upward direction, and a third sub-insulating layer connecting the first sub-insulating layer to the second sub-insulating layer;
a second insulating layer provided on the first insulating layer and which is in contact with the second sub-insulating layer; and
a first liquid crystal layer which selectively transmits or reflects the light provided from the light-guiding substrate, and
wherein the first liquid crystal layer is disposed in each of first cavities which are defined as closed spaces enclosed by the first sub-insulating layer, the third sub-insulating layer, and the second insulating layer.

2. The display device of claim 1, wherein the first liquid crystal layer comprises a plurality of first liquid crystal molecules having a first liquid crystal pitch, and
each of the first liquid crystal molecules is a cholesteric liquid crystal molecule.

3. The display device of claim 2, wherein the first liquid crystal layer reflects light, which is provided from the light-guiding substrate and has a wavelength within a first wavelength band, and transmits light, which is provided from the light-guiding substrate and has a wavelength out of the first wavelength band.

4. The display device of claim 3, wherein the display module comprises:
a retardation film provided on the optical filter and which delays a phase of one component of light passing therethrough by λ/4, wherein λ is a wavelength of the light;
an encapsulation substrate provided on the retardation film and which faces the retardation film; and
a nematic liquid crystal layer interposed between the retardation film and the encapsulation substrate.

5. The display device of claim 4, wherein the nematic liquid crystal layer comprises a plurality of nematic liquid crystal molecules.

6. The display device of claim 3, wherein the first liquid crystal layer further comprises a curable polymer material.

7. The display device of claim 3, wherein the first insulating layer and the second insulating layer are provided to define second cavities therebetween,
the second cavities are adjacent to the first cavities,
the optical filter further comprises a second liquid crystal layer which is disposed in each of the second cavities and selectively transmits or reflects the light provided from the light-guiding substrate,
the second liquid crystal layer comprises a plurality of second liquid crystal molecules having a second liquid crystal pitch different from the first liquid crystal pitch, and
each of the second liquid crystal molecules is a cholesteric liquid crystal molecule.

8. The display device of claim 7, wherein the second liquid crystal layer reflects light, which is provided from the light-guiding substrate and has a wavelength within a second wavelength band, and transmits light, which is provided from the light-guiding substrate and has a wavelength out of the second wavelength band.

9. The display device of claim 4, wherein the display module further comprises:
a polarizing layer disposed between the encapsulation substrate and the nematic liquid crystal layer; and
an optical conversion member provided between the encapsulation substrate and the polarizing layer, wherein the optical conversion member comprises a plurality of quantum dots.

10. The display device of claim 4, wherein the display module further comprises a polarizing layer provided on the encapsulation substrate.

11. The display device of claim 1, wherein the optical filter further comprises:
a third insulating layer which includes a fourth sub-insulating layer in contact with a top surface of the second insulating layer, a fifth sub-insulating layer spaced apart from the top surface of the second insulating layer in the upward direction, and a sixth sub-insulating layer connecting the fourth sub-insulating layer to the fifth sub-insulating layer;
a fourth insulating layer provided on the third insulating layer and which is in contact with the fifth sub-insulating layer; and
a third liquid crystal layer which selectively transmits or reflects light provided from the first liquid crystal layer,
wherein the third liquid crystal layer is disposed in each of third cavities, which are defined as closed spaces enclosed by the fourth sub-insulating layer, the sixth sub-insulating layer, and the fourth insulating layer.

12. The display device of claim 11, wherein the first liquid crystal layer comprises a plurality of first liquid crystal molecules having a first liquid crystal pitch,
the third liquid crystal layer comprises a plurality of third liquid crystal molecules having a third liquid crystal pitch different from the first liquid crystal pitch, and
each of the first liquid crystal molecules and the third liquid crystal molecules is a cholesteric liquid crystal molecule.

13. The display device of claim 12, wherein the third liquid crystal layer reflects light, which is provided from the first liquid crystal layer and has a wavelength within a third wavelength band, and transmits light, which is provided from the first liquid crystal layer and has a wavelength out of the third wavelength band.

14. The display device of claim 13, wherein the first liquid crystal layer overlaps with the third liquid crystal layer in a plan view.

15. The display device of claim 13, wherein the first liquid crystal layer is spaced apart from the third liquid crystal layer in a plan view.

16. The display device of claim 11, wherein the first liquid crystal layer and the third liquid crystal layer comprise a plurality of first liquid crystal molecules having a first liquid crystal pitch, and each of the first liquid crystal molecules is a cholesteric liquid crystal molecule.

17. The display device of claim 1, wherein the third sub-insulating layer has a cylinder shape, and a diameter of each of the first cavities in a plan view increases in the upward direction.

18. The display device of claim 1, further comprising a reflecting member provided below the optical module.

19. A display device, comprising:
a display module which displays an image and comprises a retardation film which delays a phase of one component of light passing therethrough by λ/4, where λ is a wavelength of the component;
a light source which generates light;
a light-guiding substrate provided below the retardation film, at least a side surface of the light-guiding substrate being provided adjacent to the light source and light-guiding substrate guiding the light provided from the light source toward the display module; and
an optical filter provided on the light-guiding substrate,
wherein the optical filter comprises:
an insulating layer which includes a first sub-insulating layer in contact with a top surface of the light-guiding substrate, a second sub-insulating layer spaced apart from the top surface of the light-guiding substrate in an upward direction, and a third sub-insulating layer connecting the first sub-insulating layer to the second sub-insulating layer; and
a liquid crystal layer which selectively transmits or reflects the light provided from the light-guiding substrate,
wherein the liquid crystal layer is disposed in each of cavities which are defined as spaces enclosed by the first sub-insulating layer, the third sub-insulating layer, and the retardation film.

20. The display device of claim 19, wherein the liquid crystal layer comprises a plurality of liquid crystal molecules having a liquid crystal pitch, and
each of the liquid crystal molecules is a cholesteric liquid crystal molecule.
